(19) United States
(12) Patent Application Publication
(10) Pub. No.: US 2023/0412582 A1
(43) Pub. Date: Dec. 21, 2023

(54) Systems and methods for Single Sign On (SSO) redirecting in the presence of multiple service providers for a cloud service

(71) Applicant: Plume Design, Inc., Palo Alto, CA (US)

(72) Inventors: Thomas F. Price, Chicago, IL (US); Crystal Wai, Redwood City, CA (US)

(21) Appl. No.: 17/751,175

(22) Filed: May 23, 2022

(51) Int. Cl. H04L 9/40

(52) U.S. Cl. CPC H04L 63/0815

(57) ABSTRACT

The present disclosure relates to systems and methods for SSO redirecting. More particularly, for identifying and authenticating a user via the user's specific service provider. A user intending to establish a connection between two cloud services, where the user is subscribed to a specific service provider in one cloud service, must provide identity authentication and consent to the cloud service. The processes described herein provide the user with an authentication token supplied by the user's specific service provider associated with a first cloud service. Utilizing the authentication token, the token being entered into a URL opened within the second cloud service, the first cloud service can identify the service provider with which the user is associated, and provide the user with means of identification authentication. Further, the URL provides the first cloud service with information for the connection to the second cloud service.

### FIELD OF THE DISCLOSURE

The present disclosure relates generally to networking and computing. More particularly, the present disclosure relates to systems and methods for Single Sign On (SSO) redirecting in the presence of multiple service providers for a cloud service.

### BACKGROUND OF THE DISCLOSURE

In order to establish a connection between a plurality of cloud systems, verification and identity authentication are required by the user to grant control and visibility of features and data from a third-party cloud. Such scenarios include the use of smart home assistants to control a user's home network, such as voice assistants, smart home devices, and the like. In many cases, users are linked with a specific service provider within a cloud service, where a plurality of service providers exist and act as Identity Providers (IDP). The users may only have identification credentials associated with the specific service provider, making it crucial for the cloud service to know what service provider a user is associated with when verification and identity authentication are required. Additionally, the user may be unaware of which cloud service they have access to, and only be aware of the specific service provider which permits the access. The present disclosure presents systems and methods for identifying and authenticating a user via the user's specific service provider to establish a secure connection between a plurality of cloud systems.

### BRIEF SUMMARY OF THE DISCLOSURE

The present disclosure relates to systems and methods for SSO redirecting. More particularly, for identifying and authenticating a user via the user's specific service provider to establish identity authentication and consent for creating a connection between a plurality of cloud services. A user intending to establish a connection between two cloud services, where the user is subscribed to a specific service provider in one cloud service, must provide identity authentication and consent to the cloud service. The processes described herein provide the user with an authentication token supplied by the user's specific service provider associated with a first cloud service. Utilizing the authentication token, the token being entered into a URL opened within the second cloud service, the first cloud service can identify the service provider with which the user is associated, and provide the user with means of identification authentication. Further, the URL provides the first cloud service with information for the connection to the second cloud service.

In an embodiment, a method implemented by a first cloud service includes steps of: presenting a user with a Uniform Resource Locator (URL) having a field for the user to input an authorization token responsive to the user selecting a feature on a second cloud service for connecting to the first cloud service; receiving the authorization token; identifying a service provider associated with the user based on the authorization token; presenting the user with a login associated with the identified service provider; and responsive to a successful login, allowing a connection between the first cloud service and second cloud service. The service provider may be one of a plurality of service providers for the first cloud service. The feature of the second cloud service enables the second cloud service to control aspects of the first cloud service. The token may be encoded with information, including information about the user's identity. The authorization token is a code provided to the user by an application associated with the service provider. The code can be a temporary code which cycles to reduce security risks. The code is generated at the time the user accesses the application or generated by a specific action to trigger the generation of the code. The service provider is an Identity Provider (IDP) for the first cloud service. The URL provided to the user is specific to the second cloud service, and the URL is operated by the first cloud service. The first cloud service is a home network, and the second cloud service is a smart home service enabled to control the home network.

In another embodiment, a method implemented by a user includes steps of: selecting a feature on a second cloud service for connecting to a first cloud service; submitting an authorization token to a Uniform Resource Locator (URL), the URL being displayed responsive to the selection of the feature; providing login information to a service provider associated with the user based on the authorization token; and responsive to a successful login, creating a connection between the first cloud service and second cloud service. The service provider may be one of a plurality of service providers for the first cloud service. The feature of the second cloud service enables the second cloud service to control aspects of the first cloud service. The token may be encoded with information, including information about the user's identity. The authorization token is a code provided to the user by an application associated with the service provider. The code can be a temporary code which cycles to reduce security risks. The code is generated at the time the user accesses the application or generated by a specific action to trigger the generation of the code. The service provider is an Identity Provider (IDP) for the first cloud service. The URL provided to the user is specific to the second cloud service, and the URL is operated by the first cloud service. The first cloud service is a home network, and the second cloud service is a smart home service enabled to control the home network.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flow diagram of user devices communicating with a plurality of cloud services via the internet.

FIG. 2 is a block diagram of a server that may be used in the cloud-based system of FIG. 1 or the like.

FIG. 3 is a block diagram of a user device that may be used with the cloud-based system of FIG. 1 or the like.

FIG. 4 is a flow diagram of an embodiment of the SSO redirecting process of the present disclosure.

FIG. 5 is a flow diagram of an additional embodiment of the SSO redirecting process of the present disclosure.

### DETAILED DESCRIPTION OF THE DISCLOSURE

Again, the present disclosure relates to systems and methods for SSO redirecting. More particularly, for identifying and authenticating a user via the user's specific service provider to establish identity authentication and consent for creating a connection between a plurality of cloud services. A user intending to establish a connection between two cloud services, where the user is subscribed to a specific service provider in one cloud service, must provide identity authentication and consent to the cloud service. The processes described herein provide the user with an authentication token supplied by the user's specific service provider associated with a first cloud service. Utilizing the authentication token, the token being entered into a URL opened within the second cloud service, the first cloud service can identify the service provider with which the user is associated, and provide the user with means of identification authentication. Further, the URL provides the first cloud service with information for the connection to the second cloud service.

### § 1.0 EXAMPLE CLOUD-BASED SYSTEM ARCHITECTURE

The cloud can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud is illustrated herein as an example embodiment of a cloud-based system, and other implementations are also contemplated.

As described herein, the terms cloud services and cloud applications may be used interchangeably. The cloud is any service made available to users on-demand via the Internet, as opposed to being provided from a company's on-premises servers. A cloud application, or cloud app, is a software program where cloud-based and local components work together.

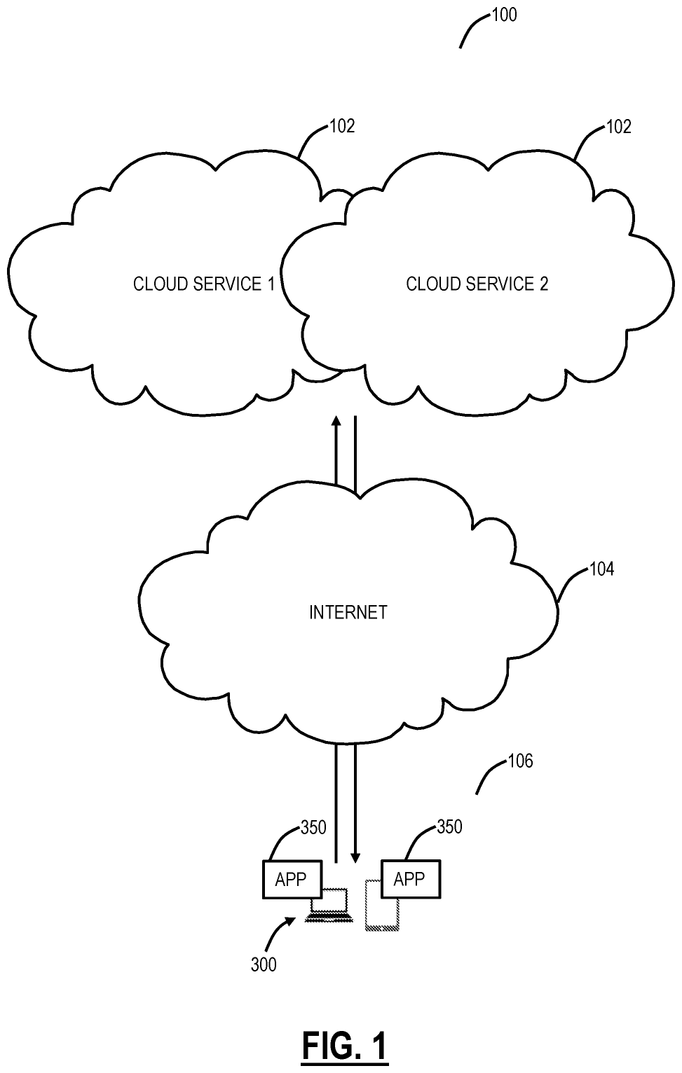

FIG. 1 is a network diagram of the cloud-based system 100 illustrating an application 350 on user devices 300 with users configured to operate through the cloud-based system 100. Different types of user devices 300 are contemplated, including mobile devices, smart home devices, wearable devices, and others of the like. The conventional approach for a user device 300 to operate with the cloud-based system 100 as well as for accessing resources includes complex user verification. The users 106 accessing the user devices 300 may be linked to a plurality of cloud service providers, providing access to the cloud services 102 via the internet 104.

### § 2.0 EXAMPLE SERVER ARCHITECTURE

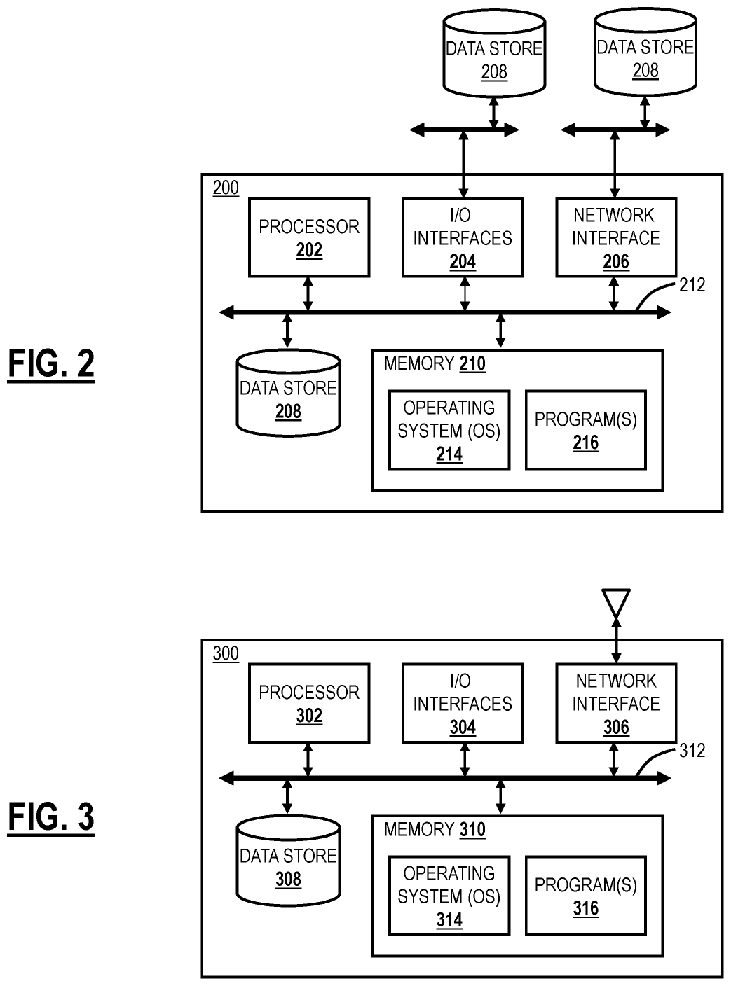

FIG. 2 is a block diagram of a server 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### § 3.0 EXAMPLE USER DEVICE ARCHITECTURE

FIG. 3 is a block diagram of a user device 300, which may be used with the cloud or the like. Specifically, the user device 300 can form a device used by one of the users 106, and this may include common devices such as laptops, smartphones, tablets, netbooks, personal digital assistants, MP3 players, cell phones, e-book readers, IoT devices, servers, desktops, printers, televisions, streaming media devices, wearable devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. The software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### § 4.0 SSO REDIRECTING

User devices 300 can include a plurality of third-party applications and integrations to send and receive control information or exchange data with a plurality of different clouds. These applications may include capabilities in which the two clouds are collaborating to make voice control of a network operate, control IoT devices, control or share information about power consumption or other utilities, and user data including health, wellness, personal wellbeing via applications on wearable devices, and other capabilities of the like. When connecting a service that is operated or managed by one cloud, to receive control information or exchange data with another cloud operated by a third party, verification and consent from the user must be made.

Providing verification of a user to a plurality of clouds and cloud services can become a problem when user credentials are different on the plurality of clouds and service providers. Additionally, risk associated with the connection can become increased when such connections can provide access control and data exchange between the clouds. The present disclosure provides systems and methods for connecting a service that is operated or managed by one cloud, to receive control information and exchange data with another cloud, the connection being validated by the user. The connection can be made between a first cloud to one of many different clouds based on which user is requesting the connection, while maintaining a common method of connection across multiple service providers.

In various embodiments, a first cloud and a second cloud are contemplated, the first cloud having a service that is managed or operated by the first cloud, and the second cloud being operated by a third party. The connection must be made with verified consent from the user, in which the user's credentials are different on the two clouds. A plurality of applications may cause the two clouds to transfer control information and exchange data. The applications may cause the clouds to collaborate to make voice control of a network operate, control IoT devices, control or share information about power consumption or other utilities, and user data including health, wellness, personal wellbeing via applications on wearable devices, and other capabilities of the like.

The first cloud may be associated with a plurality of service providers, with users being subscribed to a specific service provider for accessing the first cloud. This introduces the complication of connecting services associated with different clouds because users may only be informed of which service provider they are associated with and may not have credentials related with the cloud itself. The plurality of service providers may additionally act as the Identity Provider (IDP), resulting in complications when the cloud provider requires authorization from a user, due to the cloud provider not knowing which IDP the user is associated with and the user not having identification credentials for the cloud itself.

The user may utilize a third-party application which resides on the second cloud and select a feature which requires a connection to the first cloud for operation. Third-party applications can include various functions which enable smart home features via voice activation and others of the like such as Amazon Alexa, Google Home, Apple Siri, or the like. When the user selects to activate such a feature on the third-party application, the present embodiment provides the user with a URL, the URL being associated with the specific third-party application and cloud, and the URL being the same no matter what service provider the user is associated with.

The authentication flow to determine which service provider the user belongs to may include the use of a token, where the token can be interpreted by the first cloud to determine the associated service provider with the user. The token can be provided by the user or read by the cloud service and can include Geo proximity, Wide Area Network (WAN) Internet Protocol (IP) address, location permission, a pull-down menu for choosing the provider, entering a name of a provider, and entering a code obtained from the service provider.

### § 4.1 SSO Redirecting Token

The tokens can allow the cloud service to identify which service provider the user is associated with. In many cases, the tokens may only work under specific conditions. If there are a plurality of service providers in a given geographical region, a geo proximity or location token may present issues in identification. Additionally, a WAN IP address will not provide a usable identification if the user is utilizing a Virtual Private Network (VPN) and will also not provide an accurate identity if the user is not on the correct network (i.e., the user's home network). Further, a user may be unaware of the specific service provider they are associated with, making it more difficult to select the correct service provider from a list or outright providing the name of the service provider.

A code obtained from the service provider (i.e., via a network application) to be entered for identification can allow the cloud service to easily and consistently identify a user's service provider without the user being required to enter specified information which may be unknown. The code can include encoded information such as the user's service provider, account number associated with the cloud service, and other information of the like. The code may be a temporary code which cycles to reduce security risks and allow a relatively short code to indicate a large amount of specific information. The code can be generated at the time a user requests the code or generated automatically upon the code being required for identification.

### § 4.2 SSO Redirecting Example

A user, on a third-party application/cloud (second cloud), may select to enable a feature which requires connection to a first cloud, the connection being for the sending and receiving of control information or exchanging data to control functions of the first cloud. In various embodiments, the first cloud is a network, and the second cloud is a smart home cloud service such as Amazon Alexa, Google Home, Apple Siri, or the like. The connection can enable a user to utilize the voice control features of the smart home services (second cloud) to control aspects of the user's home network (first cloud). After selecting to enable the feature, the user is presented with an authorization URL associated with the first cloud service where the user is able to input a code (identification token) for identification. Again, the identification token is needed because users of the first cloud may be associated with one of a plurality of service providers which act as an IDP for the cloud service. The identification token is used to identify which service provider the user is associated with to establish a connection. Once the identification token is entered, the cloud service identifies the specific service provider associated with the user, and the user is presented with a login page associated with the service provider for the user to authenticate. Once the user successfully authenticates via the service providers login page, the service provider returns an authentication token to the first cloud service validating the user's identity. The authentication token can include information such as the user's account number and the like. Once the cloud service validates the user's identity, the cloud service sends a validation token to the third-party application/cloud, allowing the third-party application specific controls of the user's network.

The user may retrieve the code (identification token) from an application associated with the service provider. Instructions for how to retrieve the code may be presented to the user on the authorization URL. If the user does not have the application associated with the service provider installed, the user will be instructed on how to download the application and further how to retrieve the code from the application.

### § 4.3 SSO Redirecting Process

Again, the present disclosure provides systems and methods for connecting a service that is operated or managed by one cloud (first cloud), to receive control information or exchange data with another cloud (second cloud) operated by a third-party. More particularly, the present disclosure provides a process for the aforementioned connection when a cloud service includes a plurality of service providers, when the specific service provider associated with a user must be known for authentication.

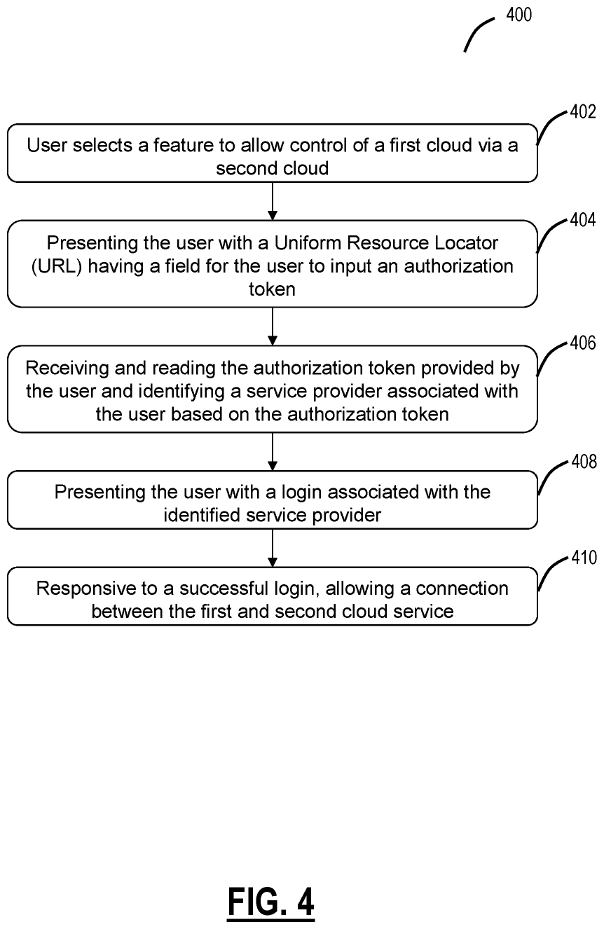

FIG. 4 is a flow diagram of an embodiment of the SSO redirecting process 400 of the present disclosure. In an embodiment, when a user wants to enable a feature of a smart home device to control aspects of a home network, it requires the connection and communication of two separate cloud services. For example, using a voice assistant to control network settings. The user selects 402 a feature to allow control of a first cloud service via a second cloud service. The selection may be through a third-party application linked to the second cloud service. The user is then presented with a URL 404 having a field for the user to input an authorization token. The URL may be loaded in a new window with the URL being provided by the first cloud service. The authorization token is received and read 406 by the first cloud service to identify which service provider the user is associated with for access to the first cloud service. The user is then provided with a login 408 associated with the identified service provider. Responsive to a successful login, allowing 410 a connection between the first and second cloud service.

The URL presented to the user responsive to the selection of a desired feature may be operated by the first cloud service. Additionally, the URL may be specific to the third-party cloud service (i.e., Amazon, Google, Apple, and others) to allow the first cloud service to identify where the connection needs to be made.

Again, the authorization token may be a code obtained from the service provider of the first cloud. The code can include encoded information such as the user's service provider, account number associated with the cloud service, and other information of the like. The code may be a temporary code which cycles to reduce security risks and allow a relatively short code to indicate a large amount of specific information. The code can be generated at the time a user requests the code or generated automatically upon the code being required for identification.

When the user authenticates via the provided service provider login in step 408, the service provider SSO redirects to the cloud (first cloud) after a successful login. The cloud then validates the token and generates a cloud token to provide to the second cloud, authenticating the action. The first cloud credentials are passed back to the second cloud, thereby connecting the two clouds to allow the second cloud to control aspects of the first cloud. Again, for example, allowing a smart home device to make changes to a user's home network. The credentials may be passed by Security Assertion Markup Language (SAML), Open Authorization (OAUTH), Open ID, and the like.

In another embodiment, an additional process is contemplated. Instead of going through the service provider SSO login to get the cloud credentials, the cloud credentials could be associated with (encoded in) a short code. In this case, upon entering the short code into the URL, the first cloud could make the connection between the second cloud feature and the first cloud immediately. However, this leaves a security risk of fishing (randomly) for short codes, and thereby becoming controllers of unknown networks. The risk of this is small as the short code is long enough to have billions of values, and the life of the code would be measured in minutes.

Various embodiments can also include failure recovery when the system detects a failure to pass the SSO login. This may include, for example, if the code includes account information, failure can be detected as a timeout and a push notification can be sent to the account noting the failure and inviting corrective action.

### § 5.0 SSO REDIRECTING ADDITIONAL PROCESS

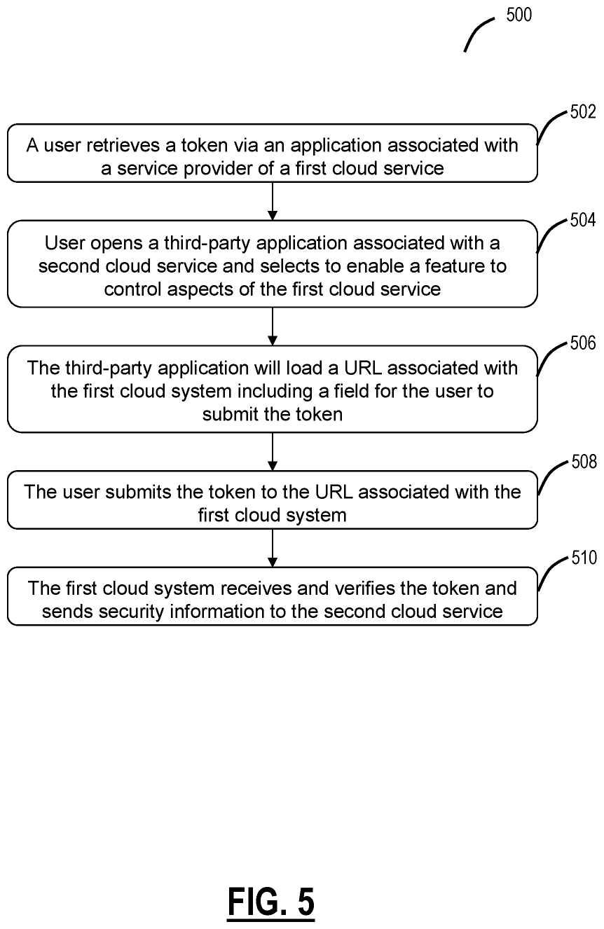

FIG. 5 is a flow diagram of an additional embodiment of the SSO redirecting process 500 of the present disclosure. A user retrieves a token 502 via an application associated with a service provider of a first cloud service. The user then opens a third-party application 504 associated with a second cloud service and selects to enable a feature to control aspects of the first cloud service. The third-party application will load a URL 506 associated with the first cloud system including a field for the user to submit the token. The user submits the token 508 to the URL associated with the first cloud system. The first cloud system receives and verifies the token 510 and sends security information to the second cloud service.

In the above process, step 508 can be replaced with the user entering their cloud service account credentials, which would allow the use of the token to be skipped. Although, in many cases the user does not know their cloud service credentials, because they acquired the service through a different service provider, and the user may only know the credentials for that service provider.

### § 6.0 CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method implemented by a first and second cloud service, the method comprising steps of:
responsive to a user requesting to connect the first and second cloud, the second cloud presenting to the user a Uniform Resource Locator (URL) to a web page having a field for the user to input an authorization token, the authorization token provided responsive to the user selecting a feature on a first cloud service for connecting the first and second cloud;
receiving the authorization token;
identifying a service provider associated with the user based on the authorization token;
presenting the user with a login associated with the identified service provider; and
responsive to a successful login, allowing a connection between the first cloud service and second cloud service.

2. The method of claim 1, wherein the service provider is one of a plurality of service providers for the first cloud service.

3. The method of claim 1, wherein the feature of the second cloud service enables the second cloud service to control aspects of the first cloud service.

4. The method of claim 1, wherein the authorization token is encoded with information, including information about the user's identity or information about which service provider is associated with the user.

5. The method of claim 1, wherein the authorization token is a code provided to the user by an application associated with the service provider.

6. The method of claim 5, wherein the code is a temporary code which cycles to reduce security risks.

7. The method of claim 5, wherein the code is generated at the time the user accesses the application or generated by a specific action to trigger the generation of the code.

8. The method of claim 1, wherein the service provider is an Identity Provider (IDP) for the first cloud service.

9. The method of claim 1, wherein the URL provided to the user is specific to the second cloud service, and the URL is operated by the first cloud service.

10. The method of claim 1, wherein the first cloud service is a home network, and the second cloud service is a smart home service enabled to control the home network.

11. The method of claim 1, wherein the first cloud service is a home network, and the second cloud service is a wellness, health, personal wellbeing, fitness, or exercise application.

12. The method of claim 1, wherein the first cloud service is a home network, and the second cloud service is a utility, energy, power consumption monitoring, or power usage control application.

13. A method implemented by a first and second cloud service, the method comprising steps of:
responsive to a user requesting to connect the first and second cloud, the second cloud presenting to the user a Uniform Resource Locator (URL) to a web page having a field for the user to input an authorization token, the authorization token provided responsive to the user selecting a feature on a first cloud service for connecting the first and second cloud;
receiving the authorization token, the authorization token having encoded within it the credentials required to connect the two clouds; and
responsive to successfully receiving the authorization token, allowing a connection between the first cloud service and second cloud service.

14. The method of claim 13, wherein a service provider is identified based on the authorization token, and wherein the service provider is one of a plurality of service providers for the first cloud service.

15. The method of claim 13, wherein the feature of the second cloud service enables the second cloud service to control aspects of the first cloud service.

16. The method of claim 13, wherein the authorization token is encoded with information, including information about the user's identity or information about which service provider is associated with the user.

17. The method of claim 13, wherein the authorization token is a code provided to the user by an application associated with the first cloud service.

18. The method of claim 17, wherein the code is a temporary code which cycles to reduce security risks.

19. The method of claim 17, wherein the code is generated at the time the user accesses the application or generated by a specific action to trigger the generation of the code.

20. The method of claim 13, wherein the URL provided to the user is specific to the second cloud service, and the URL is operated by the first cloud service.

21. The method of claim 13, wherein the first cloud service is a home network, and the second cloud service is a smart home service enabled to control the home network.

22. The method of claim 13, wherein the first cloud service is a home network, and the second cloud service is a wellness, health, personal wellbeing, fitness, or exercise application.

23. The method of claim 13, wherein the first cloud service is a home network, and the second cloud service is a utility, energy, power consumption monitoring, or power usage control application.
